(19) United States
(12) Patent Application Publication
(10) Pub. No.: US 2022/0263060 A1
(43) Pub. Date: Aug. 18, 2022

(54) LASER ABLATION FOR LITHIUM-ION BATTERIES

(71) Applicant: Alliance for Sustainable Energy, LLC, Golden, CO (US)

(72) Inventors: Donal Patrick FINEGAN, Lakewood, CO (US); Kandler Alan SMITH, Golden, CO (US); Dana Birute KERN, Golden, CO (US); Bertrand Jean-Francois Tremolet de VILLERS, Golden, CO (US); Andrew Michael COLCLASURE, Morrison, CO (US); Francois Laurent Emilien USSEGLIO-VIRETTA, Lakewood, CO (US)

(21) Appl. No.: 17/651,093

(22) Filed: Feb. 15, 2022

Related U.S. Application Data
(60) Provisional application No. 63/149,466, filed on Feb. 15, 2021.

(51) Int. Cl. H01M 4/13; H01M 10/0525; H01M 4/139; H01M 4/04; B23K 26/06

(52) U.S. Cl. CPC H01M 4/13; H01M 10/0525; H01M 4/139; H01M 2004/021; B23K 26/0643; B23K 26/0648; H01M 4/04

(57) ABSTRACT

The present disclosure relates to utilizing laser ablation to selectively remove regions of active material from lithium-ion battery electrodes during production, forming channels. These channels may improve the radius of curvature of the lithium-ion battery, form patterns on the surface of the electrode to store excess electrolyte, provide improved access to external sources of lithium during pre-lithiation or re-lithiation, and/or lower the tortuosity of electrodes for enhanced ion transfer between electrodes during cycling in prismatic cells and cylindrical cells.

### CROSS-REFERENCE TO RELATED APPLICATIONS

This application claims priority to U.S. Provisional Patent Application No. 63/149,466 filed on Feb. 15, 2021, the contents of which are incorporated herein by reference in their entirety.

### CONTRACTUAL ORIGIN

This invention was made with United States government support under Contract No. DE-AC36-08GO28308 awarded by the U.S. Department of Energy. The United States government has certain rights in this invention.

### BACKGROUND

Lithium-ion batteries are increasingly used for compact applications, such as wireless ear pods, and compact medical devices, such as pacemakers. These designs require battery electrodes to be wound up into very small spaces with tight radii of curvature (i.e., very tightly wound). In some applications, the inner electrode layers in these wound electrodes may experience a radius of curvature of less than 5 mm. Such tight winding can cause the coating layer of the electrode material to delaminate from the current collector and/or tear the current collector. High energy density lithium-ion cells with thick (i.e., greater than 100 μm) electrodes have higher limits of radii of curvature before such damage occurs than thinner electrodes. These space restrictions mean that thick electrodes cannot be used, as thick electrodes may crack and/or delaminate when the electrodes bend around the small radius of curvature.

During cycling of lithium-ion batteries, lithium ions must homogenously lithiate particles throughout all depths of the electrode in the battery. The ionic conductivity, or ease for lithium ions to travel through a medium, of the electrolyte limits how quickly lithium can travel to and from electrodes during cycling. The tight winding required for small battery applications often prevents the electrolyte from being able to penetrate beyond the surface of the electrode. Thus, there remains a need for thick electrodes to be able to be wound tightly without cracking or delamination and to allow electrolyte to penetrate deep into the electrode roll.

### SUMMARY

An aspect of the present disclosure is a device including a lithium-ion battery which includes an electrode having a channel, in which the electrode has a length, a width, and a thickness, the channel extends into a first portion of the length of the electrode, the channel extends into a second portion of the width of the electrode, and the channel extends into a third portion of the thickness of the electrode. In some embodiments, the first portion is in the range of about 5 μm to about 50 μm. In some embodiments, the second portion is in the range of about 5 μm to about 50 μm. In some embodiments, the second portion is approximately equivalent to the width of the electrode. In some embodiments, the third portion is in the range of about 5 μm to about 50 μm. In some embodiments, the third portion is about 100 μm or less. In some embodiments, the device also includes an electrolyte, and a portion of the electrolyte is present in the channel.

An aspect of the present disclosure is a method for improving the performance of a lithium-ion battery, and the method includes forming a channel in an electrode of the lithium-ion battery using a laser source configured to emit a beam, in which the beam has a size, the electrode has a length, a width, and a thickness, the channel extends into a first portion of the length of the electrode, the channel extends into a second portion of the width of the electrode, and the channel extends into a third portion of the thickness of the electrode. In some embodiments, the first portion is approximately equivalent to the size of the beam. In some embodiments, the first portion is approximately equivalent to the length. In some embodiments, the second portion is approximately equivalent to the size of the beam. In some embodiments, the second portion is approximately equivalent to the width. In some embodiments, the third portion is approximately equivalent to the size of the beam. In some embodiments, the third portion is less than about 100 μm. In some embodiments, the forming includes pulsing the laser to remove material from the electrode to form the channel. In some embodiments, the method also includes applying an electrolyte to the electrode and during the applying a portion of the electrolyte is present in the channel.

An aspect of the present disclosure is a system for performing laser ablation on an electrode of a lithium-ion battery, and the system includes a laser source configured to emit a beam, a laser optics, and a stage configured to hold the electrode, in which the laser optics is configured to direct the beam to perform laser ablation on the electrode which results a channel on the electrode. In some embodiments, the laser source includes a femtosecond laser. In some embodiments, the laser optics includes a laser mirror, a laser lens, a laser window, a laser filter, ultrafast optics, laser beam expanders, laser beam splitters, a crystal, an isolator, a speckle reducer, and/or a laser prism. In some embodiments, the system includes a gas source, in which the gas source is oriented towards the stage, and the gas source is configured to remove any debris caused by the laser ablation.

### BRIEF DESCRIPTION OF THE DRAWINGS

Some embodiments of the present disclosure are illustrated in the referenced figures of the drawings. It is intended that the embodiments and figures disclosed herein are to be considered illustrative rather than limiting.

FIGS. 1A-B illustrates an exemplary laser ablation system, according to some aspects of the present disclosure.

FIG. 2 illustrates a scanning electron micrograph (SEM) image showing channels removed from a battery electrode, according to some aspects of the present disclosure.

FIG. 3 illustrates (panel a) cracking in a standard electrode after being wound, and (panel b) lack of cracking due to the laser-created channel in an electrode treated with laser ablation, according to some aspects of the present disclosure.

FIG. 4 illustrates (left) a standard/pristine electrode and (right) an electrode treated with laser ablation to form channels (or patterns), according to some aspects of the present disclosure.

FIG. 5 illustrates the effect of using lasers to create channels on an electrode sheet to improve access of lithium to distant regions of the electrode, according to some aspects of the present disclosure.

FIG. 6 illustrates the effect of using laser ablation to remove a pit of material for electrolyte to occupy, creating an electrolyte well in an electrode, according to some aspects of the present disclosure.

FIG. 7 illustrates (top) a cross section view of a baseline electrode with arrows indicating the tortuous route of ions from the surface of the electrode to the current collector and (bottom) a cross section of an electrode with a straight channel removed to provide a direct path into the electrode with lower tortuosity and distance traveled for ions, according to some aspects of the present disclosure.

FIG. 8 illustrates a cross-sectional SEM image of an electrode with a channel formed by laser ablation and a corresponding modeled distance map showing how the channel reduces the local distance that ions must travel from the surface of the electrode into the bulk of the electrode, according to some aspects of the present disclosure.

FIG. 9 illustrates an electrode with laser-created channels, according to some aspects of the present disclosure.

FIG. 10A illustrates a SEM image of an electrode surface showing channels made by laser ablation for local electrolyte storage, according to some aspects of the present disclosure. FIG. 10B illustrates profilometry data showing the channels in FIG. 10A to be approximately 90 μm in depth, according to some aspects of the present disclosure. FIG. 10C illustrates an approximate shape of the channels shown in FIGS. 10A-B, according to some aspects of the present disclosure.

FIG. 11 illustrates (panel a) an electrode having channels formed by laser ablation, and (panel b) a wetting comparison after approximately one (1) minute on electrodes with and without channels made by laser ablation, according to some aspects of the present disclosure.

FIG. 12 illustrates the capacity achieved during an approximately 0.6 C constant current charge for pristine and laser ablation-treated electrodes, showing an improvement in the state of charge (SOC) for the electrodes treated with laser ablation, according to some aspects of the present disclosure.

FIG. 13 illustrates a method for improving the performance of a lithium-ion battery, according to some aspects of the present disclosure.

### REFERENCE NUMBERS

100 . . . system
105 . . . laser source
110 . . . laser optics
115 . . . stage
120 . . . gas source
125 . . . electrode
200 . . . device
205a . . . channel (channel)
205b . . . channel (pore)
205c . . . channel (slice)
210 . . . crack
300 . . . method
305 . . . forming
310 . . . applying

### DESCRIPTION

The embodiments described herein should not necessarily be construed as limited to addressing any of the problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The present disclosure relates to utilizing laser ablation to selectively remove regions of active material from lithium-ion battery electrodes during production. In some embodiments, laser ablation may remove a portion of the electrode, forming channels. These channels may improve the radius of curvature of the lithium-ion battery, form patterns on the surface of the electrode to store excess electrolyte, provide improved access to external sources of lithium during pre-lithiation or re-lithiation, and/or lower the tortuosity of electrodes for enhanced ion transfer between electrodes during cycling in prismatic cells and cylindrical cells.

Increasing the thickness of electrodes may increase the energy density of the batteries, but with increasing thickness, the distance that an ion must travel increases, and thus the ability of electrodes to homogenously accept lithium ions is hindered. By milling channels (i.e., micro-holes) in the thick electrode, low tortuosity paths may be provided for lithium ions to reach deeper regions in the electrode more quickly than before, thus reducing lithium concentration gradients and allowing increasingly thick electrodes to operate at a specific discharge rate (or C rate). The present disclosure may remove material with micrometer control to introduce patterns on the electrode to alleviate the stresses of bending.

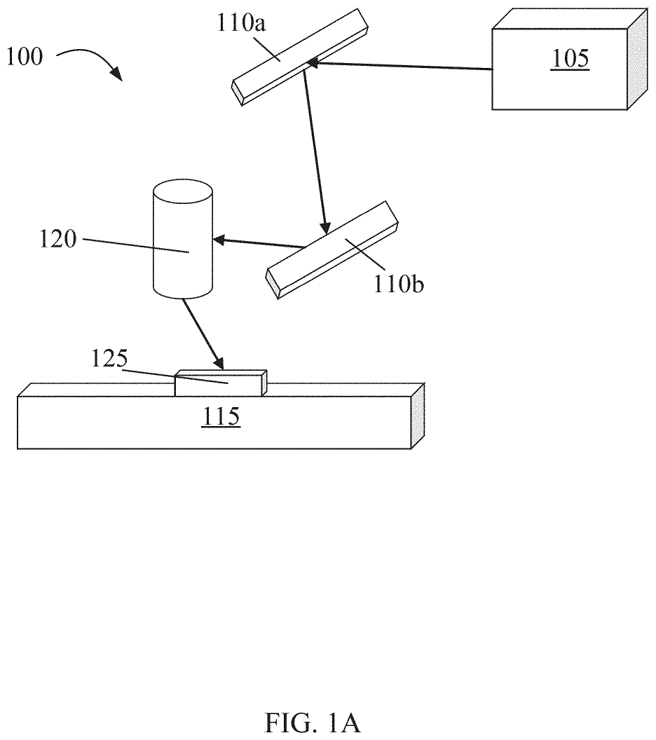

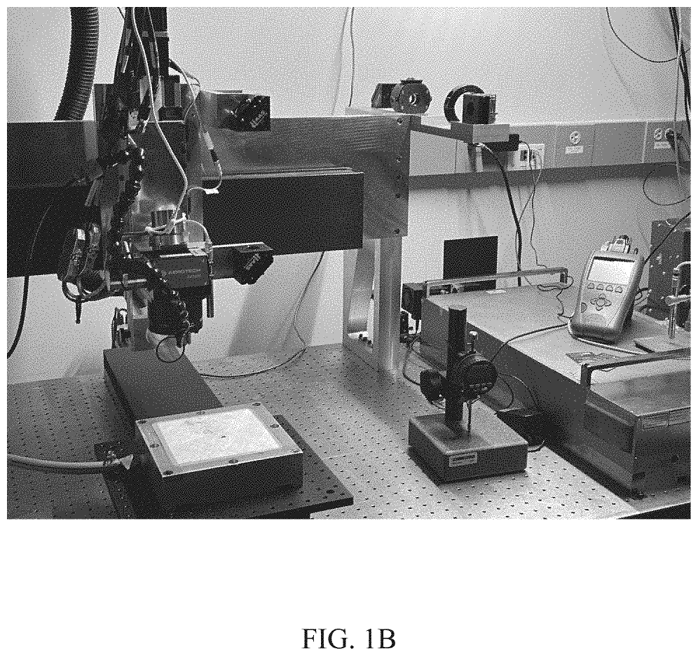

FIGS. 1A-B illustrate an exemplary laser ablation system 100, according to some aspects of the present disclosure. As shown in FIG. 1A, the system 100 includes a laser source 105, a pair of laser optics (110a and 110b), a gas source 120, and a stage 115 for placing the electrode 125. Although a pair of mirrors (i.e., laser optics) 110a and 110b are shown in FIG. 1A, a single laser optics 110a could be used, or more laser optics (e.g., three, four, five, six, seven, eight, nine, ten, etc.) could be used. Laser optics 110 may include a laser mirror, a laser lens, a laser window, a laser filter, ultrafast optics, laser beam expanders, laser beam splitters, a crystal, an isolator, a speckle reducer, and/or a laser prism. The laser optics 110 may be capable of directing and/or focusing the beam from the laser source 105 onto the electrode 125. As the shape, size, and/or location of the channel (not shown in FIGS. 1A-B) is changed, the laser optics 110 may be adjusted to facilitate this change.

FIG. 1B shows a photograph of an exemplary ultrafast laser ablation system 100, in bench top scale. The system 100 includes a laser source 105, which in this example is an Adaptive Optics femtosecond laser. A femtosecond laser is an infrared laser with a wavelength of about 1050 nm. A femtosecond laser may have incredibly rapid (i.e., ultrafast) pulses (for example, a single pulse may be about one trillionth of a second (i.e., 10⁻¹² or a picosecond) or even one quadrillionth of a second (i.e., 10⁻¹⁵ or a femtosecond). The system 100 includes laser optics 110, which in this example is translational, multi-axis galvo-mirror beam steering assembly with f-theta scanning lens, a stage 115, which in this example is a vacuum sample mount, and a gas source 120, which in this example is an active nitrogen gas flow across the stage 115 (i.e., the laser scribing location). In this example, the laser source 105 has a pulse-width of approximately 600 fs, output at approximately 1030 nm, repetition rate ranging from about 100 kHz to about 1 MHz, and an average power of approximately 10 W. In this example, the beam steering optics 110 were be coated for about 1030 nm. The system 100 as shown in FIG. 1B includes technologies which may be scaled up for in-line laser processing of roll-to-roll electrodes. For the system 100 shown in FIG. 1B, the laser optics 110 may be capable of adjusting the location the laser source 105 contacts the electrode 125 with a precision of about 1 when creating patterns.

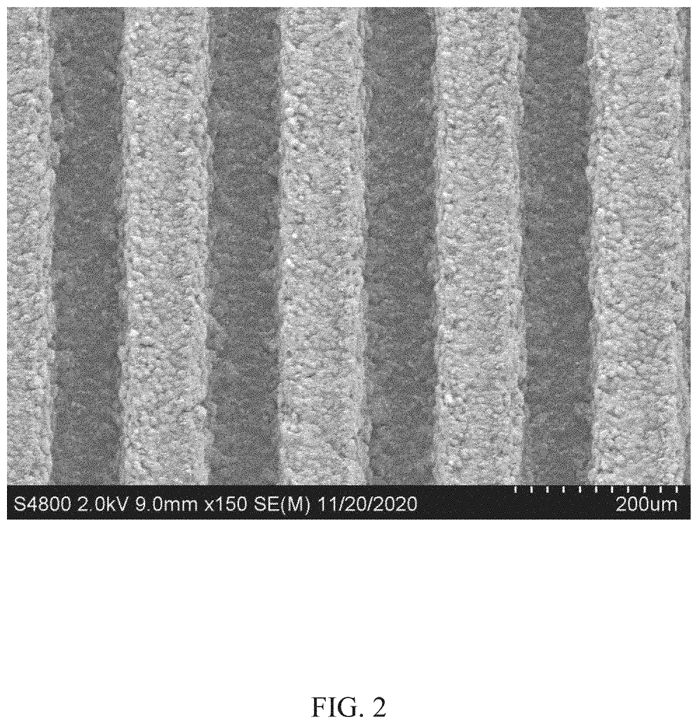

FIG. 2 illustrates exemplary micro-channels removed from a battery electrode 125, according to some aspects of the present disclosure. In this example, the electrode 125 is a lithium nickel manganese cobalt oxide (LiNi_{0.5}Mn_{0.3}Co_{0.2}O₂ or NMC532) cathode. In this example, the channels formed from a laser source 105 (not shown) (i.e., laser-ablated microchannels) have a width of approximately 40 μm. In this example, the channels do not extend through the thickness of the electrode, they only go through a portion of the thickness. In this example, the channels are substantially parallel to each other and substantially straight, however, other configurations of channels may be used (i.e., curved, tangential, zigzag, etc.).

The electrode 125 shown in FIG. 2 was used in a spiral wound battery typically used in very compact electronics such as wireless in-ear headphones (i.e., earbuds). Due to the necessary small radius of curvature for such applications, the manufacturers cannot use thick electrodes 125 because the small radius of curvature makes the electrode crush in on itself, delaminate, and/or crack. In some embodiments, wedges may be removed from thick electrodes 125 with micrometer precision to enable the use of the thick electrodes 125 in compact applications. This may significantly improve the radius of curvature of the electrodes 125.

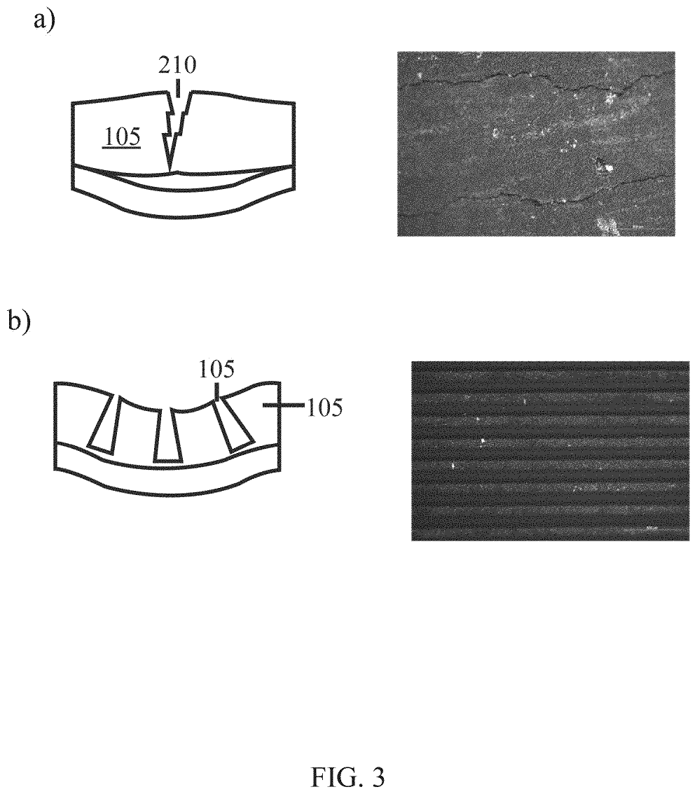

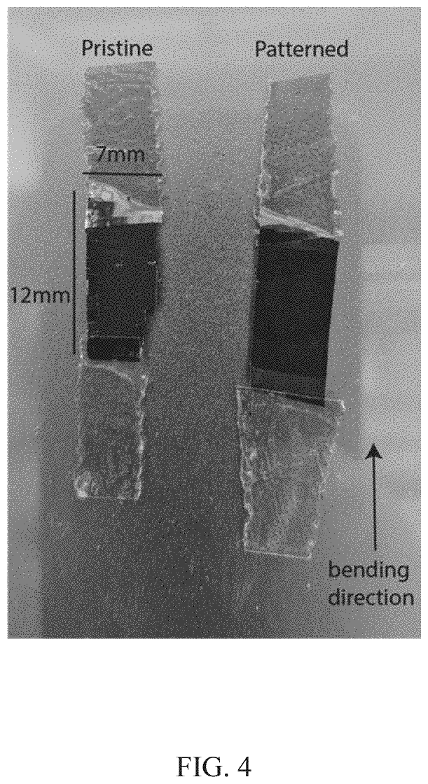

FIG. 3 illustrates (panel a) cracking in a standard electrode after being wound, and (panel b) lack of cracking due to the laser-created channel in an electrode treated with laser ablation, according to some aspects of the present disclosure. For FIG. 3, approximately 7 mm by approximately 12 mm NMC532 cathode samples (shown in of FIG. 4) were manually wrapped around an approximately 2 mm diameter steel rod to mimic the bending required in jelly roll (i.e., cylindrical) battery uses. The long axis of the samples shown in FIG. 4 were wrapped around the rod in approximately two (2) wraps (rod circumference approximately 6.3 mm). The electrode with a pattern of channels created by laser ablation was wrapped such that the channels were substantially parallel to the long axis of the rod. After wrapping, each sample was carefully unwrapped and attached to a glass slide. FIG. 3 shows the optical microscope images of both electrodes at 5× magnification. The pristine/untreated electrode shows obvious cracks resulting from the bending around the small-diameter rod and consequent crunching of the electrode. However, the laser-treated patterned electrode shows essentially no evidence of cracking, demonstrating superior ability to be bent around a small radius of curvature. FIG. 3 illustrates that the present disclosure may reduce the risk of crushing and delamination of electrodes, as well as tearing of current collectors, in tightly wound electrodes with low radii of curvature, such as in prismatic cells and cylindrical (i.e., jelly roll) cells.

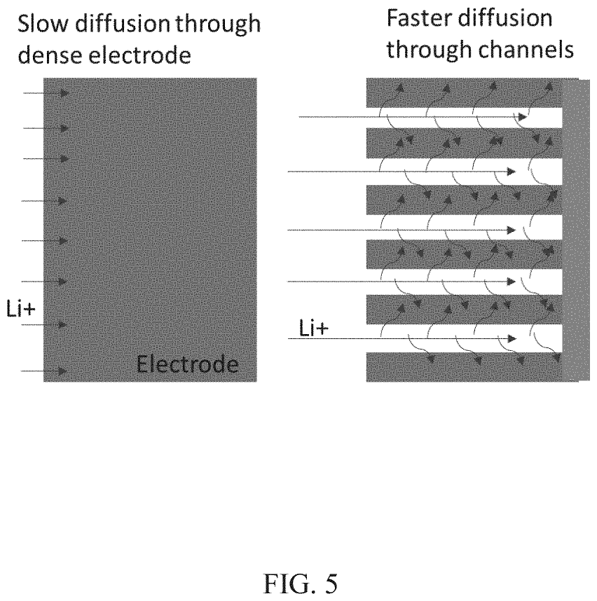

FIG. 5 illustrates the effect of using lasers to create channels on an electrode sheet to improve access of lithium to distant regions of the electrode, according to some aspects of the present disclosure. When lithium-ion batteries are made, the electrode assemblies consist of tightly wound dense layers with little access to inner regions of active material from the perimeter of the electrodes (as shown in the left side of FIG. 5). This restricts addition/permeation of lithium from an external source due to such tight packing. By incorporating channels in the electrode that are accessible from the perimeter, avenues to regions that are otherwise difficult to reach are created for external sources of lithium (shown in the right side of FIG. 5). This may be useful at the beginning of life and end of life of cells, where top up of the lithium inventory of the cell would be useful for both mass savings (from a lower positive to negative ratio) during the life of the cell, and for prolonging the life of the cell after it reaches its end of life (at approximately 80% of original capacity).

During the manufacturing process of lithium-ion batteries, a critical step is to wet the electrodes with electrolyte. This ensures that there is ionic contact with active materials and that the cell's capacity may be fully accessed during cycling. During extensive cycling, cathodes particles crack and increase the porosity of the cathode which is perceived as irreversible swelling of the cell. This swelling consumes excess electrolyte which traditionally remains present around the perimeter of the electrode. This makes it challenging for the electrolyte to penetrate from the perimeter deep into the electrode. This prevents the electrolyte from being able to fully wet the new surfaces and thus ionic contact loss may occur within the degraded electrode which further exacerbates capacity fade.

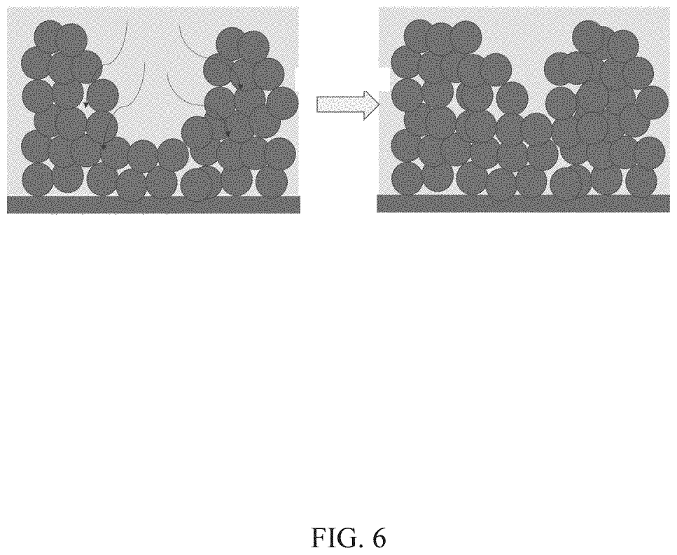

The present disclosure includes storing small amounts of electrolyte within the electrode which can be used when needed near the region of storage. This may include introducing micrometer-scale features. The present disclosure includes manufacturing the electrodes with small holes that act as electrolyte wells for when excess electrolyte is needed later in the life of the cell, thus helping extend the life of the cells by prolonging good ionic contact with active material surfaces. In some embodiments, a femtosecond laser may be used to provide the necessary precision to form these wells. An example of an electrolyte well created by laser ablation in a fresh electrode and showing the electrolyte well after cycling is shown in FIG. 6.

FIG. 6 illustrates the effect of using laser ablation to remove a pit of material for electrolyte to occupy, creating an electrolyte well in an electrode, according to some aspects of the present disclosure. The electrode particles in electrolyte exist on a current collector in both sides of FIG. 6. As the electrode ages, it swells, upon which the excess electrolyte will match the increase in volume as well as accommodating the expansion of material sides (i.e., into the well) instead of upwards (i.e., thickening the electrode). For the degraded electrode (right side) the electrolyte well provides space for the swollen degraded electrode and provides a source of additional electrolyte (compared to an electrode not treated with laser ablation as described herein).

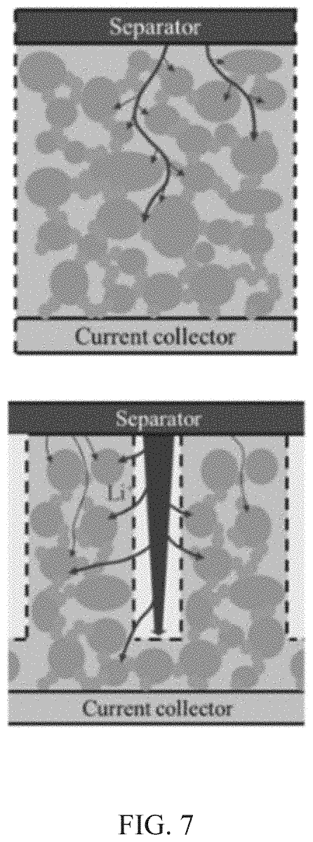

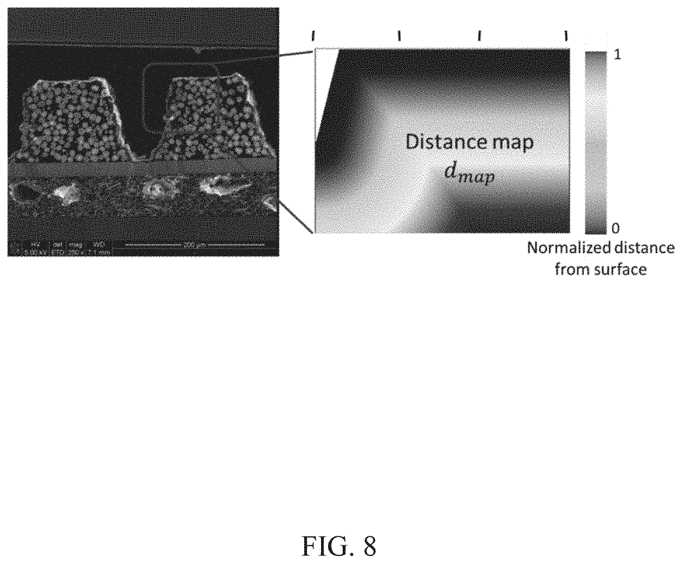

FIG. 7 illustrates (top) a cross section view of a baseline electrode with arrows indicating the tortuous route of ions from the surface of the electrode to the current collector and (bottom) a cross section of an electrode with a straight channel removed to provide a direct path into the electrode with lower tortuosity and distance traveled for ions, according to some aspects of the present disclosure. In a battery, ions (e.g., lithium (Li+), sodium (Na+), etc.) must travel through a tortuous network of particles, conductive carbon, and binder. The time it takes for ions to reach all regions throughout the electrode thickness limits the rate at which the battery can charge or discharge. As shown in FIG. 7, creating channels using laser ablation provides multiple paths for lithium ions to travel in an electrode, increasing their permeation into the electrode.

FIG. 8 illustrates a cross-sectional SEM image of an electrode with a channel formed by laser ablation and a corresponding modeled distance map showing how the channel reduces the local distance that ions must travel from the surface of the electrode into the bulk of the electrode, according to some aspects of the present disclosure. As discussed, a serious limitation of thick electrodes is the reduced ability of lithium to reach the full depth of the electrode due to the tortuous network of particles and binder. Lithium must navigate around obstacles in the electrode to access deeper regions for storage. The present disclosure relates to removing some obstacles to clear a way for lithium to permeate deeper into thick electrodes using precise laser ablation. In FIG. 8 (right side), a distance map is modeled in an electrode with channels created using laser ablation. The distance is represented by a heat graph, showing the highest distance in the lower right corner and the lowest distance in the upper left corner. The right side of the heat map is representative of a standard flat electrode, whereas the left side of the heat map shows the equivalent distance map for an electrode with laser-ablated channels as described by the present disclosure. FIG. 8 illustrates that a substantial reduction in the distance that lithium must travel is achieved when the electrode is treated with laser ablation as described herein. In some embodiments of the present disclosure, a lithium traveling distance may be similar to the average distance of standard thinner electrodes, thus enabling thicker electrodes to perform equivalently to thinner electrodes. For comparison, a typical “thin” electrode may have a thickness of less than about 70 μm, and some may have a thickness in the range of about 30 μm to about 55 μm. This also enables thicker electrodes in high-energy density lithium-ion batteries without concern of inactive regions occurring due to long distances.

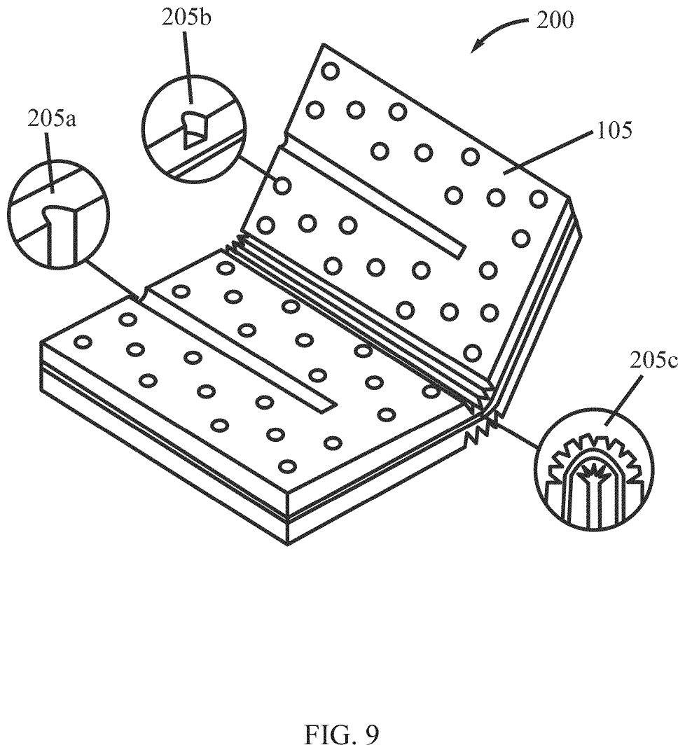

FIG. 9 illustrates an electrode 200 with laser-created channels 205, according to some aspects of the present disclosure. The electrode 200 illustrates the different types of channels 205 which may be created using laser ablation, as described herein. First, a channel 205a is shown, which does not extend through the full thickness of the electrode 200 but enables electrolyte to better permeate the electrode (as shown in FIGS. 5-8). The channel 205a shown in FIG. 9 is substantially straight, but any design or pattern may be used. Other configurations of channels 205a may be a plurality of substantially straight parallel lines, a plurality of curved or swirled lines, a plurality of angled (i.e., zig-zagged) lines, a single substantially straight line, a single curved line, and/or a single angled line. In some embodiments, trapezoidal channels 205a having widths in the range of 25-100 μm may be patterned into the electrode 200.

Next, a channel 205b in the form of a pore or electrolyte well is shown. Similar to channel 205a, the channel 205a does not extend through the full thickness of the electrode 200. The channel 205b may be substantially circular, elliptical, triangular, square, rectangular, trapezoidal, polygonal, or another shape. A plurality of channels 205b may be formed in a pattern or distributed across the surface of an electrode. Various configurations may be used to create channels 205b which enable electrolyte permeation within the electrode and storage of electrolyte in the surface of the electrode, as shown in FIGS. 5-8.

Next, a channel 205c is shown in the form of a slice or extended channel. The channel 205c may extend through the width (but not the thickness) of the electrode 200. The channel 205c may be created in a cluster or series of channels 205c. These channels 205c may be spaced based on how the electrode 200 will ultimately be cut, folded, rolled, and/or formed to create the battery. For example, a plurality of channels 205 may be cut in several clusters or series based on where the electrode 200 will be needed to bend in the final battery design. The channels 205c may be substantially straight, and if they are in a cluster or series the channels 205c may be substantially parallel. The formation of the channels 205c may enable the electrode 200 to bend and/or roll as needed to create the battery without cracking. As shown in panel b) of FIG. 3, the channel 205c may be a wedge enabling the electrode 200 to more easily bend and/or roll. Additionally, the spacing of channels 205c may be further optimized for specific radii of curvature (e.g., channels 205c may be closer together (i.e., smaller spacings) for smaller radii of curvatures).

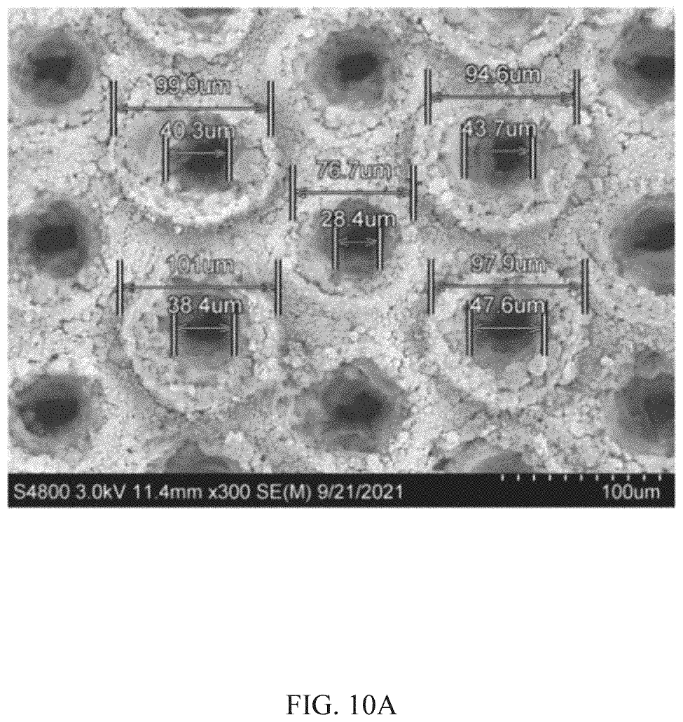

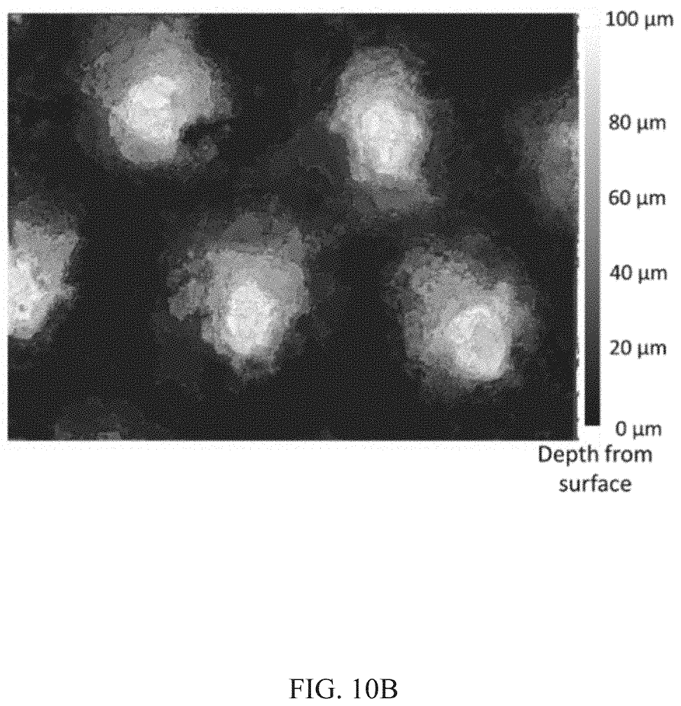

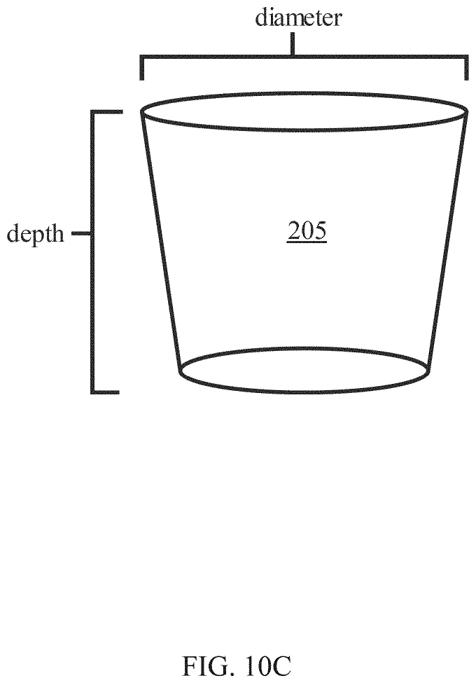

FIG. 10A illustrates a SEM image of an electrode 200 surface showing channels 205b (i.e., electrolyte wells) made by laser ablation for local electrolyte storage, according to some aspects of the present disclosure. In the example shown in FIG. 10A, the channels 205b had measured widths of approximately 40 μm in diameter. However, the widths of channels 205 may range in width based on the specifications of the laser used. The size of a single laser beam may be the lower limit of the width. Depending on the type of laser and optics set up, this may be in the range of about 5 μm to about 50 μm. However, the channels 205 may have a maximum width of the length or width of the electrode 200. Additionally, the width of channels 205 may vary throughout a single channel 205, such that the channel 205 may not be of uniform width. In some embodiments, a channel 205 may extend through the length of the electrode 200 (for example, if the electrode 200 has a length of 100 m, the channel 205 may have a length of 100 m). In other embodiments, the channel 205 may have a length limited to the size of a single laser beam (for example, in the range of about 5 μm to about 50 μm). Typically, the length of the channel 205 may be within these ranges (i.e., between the size of a single laser beam and the full length of the electrode 200).

FIG. 10B illustrates profilometry data showing the channels 205b in FIG. 10A to be approximately 90 μm in depth, according to some aspects of the present disclosure. The depth of the channels 205 may range from about 0.5 μm to about 100 μm. Additionally, the depth of channels 205 may vary throughout a single channel 205, such that the channel 205 may not be of uniform depth.

FIG. 10C illustrates an approximate shape of the channels 205 shown in FIGS. 10A-B, according to some aspects of the present disclosure. The example channel 205 shown in FIG. 0.10C has an average estimated volume of approximately 100,000 μm. As shown in FIG. 10C, the channels 205 may have a width that various throughout the depth of the channel 205. Note that the cylindrical shape shown in FIG. 10C is an example, other shapes could be used, such as a cube, triangular prism, cuboid, polygonal prism, or a combination thereof.

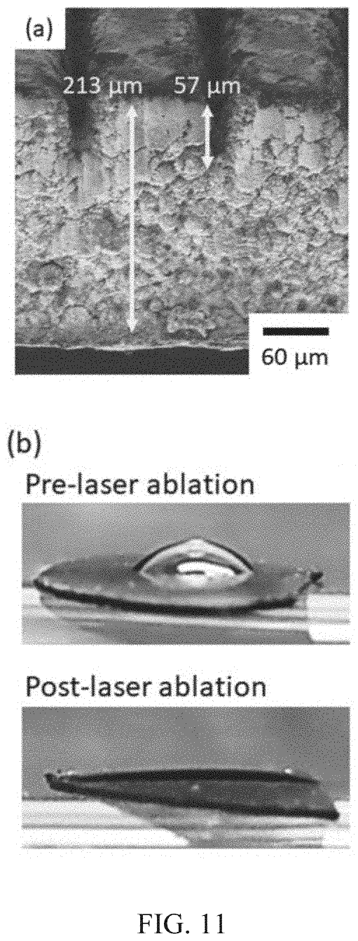

FIG. 11 illustrates (panel a) an electrode 200 having channels 205 formed by laser ablation, and (panel b) a wetting comparison after approximately one (1) minute on electrodes 200 with and without channels 205 made by laser ablation, according to some aspects of the present disclosure. The channels 205 shown in panel a) of FIG. 11 are approximately 50 μm deep, roughly one fourth (¼) of the depth of the electrode 200. That is, the exemplary channels 205 shown in panel a) of FIG. 11 only extend into about ¼ of the thickness of the electrode 200. Panel b) of FIG. 11 illustrates the superior wetting (or permeation) enabled with the channels 205 formed using laser ablation, as described herein. A droplet of electrolyte was placed on the electrode 200 surface and the photos shown in panel b) of FIG. 11 were taken after about one (1) minute. The electrolyte used in this example was approximately 1 M lithium hexafluorophosphate (LiPF₆ in an ethylene carbonate: ethyl methyl carbonate mixture). As shown in FIGS. 5-7, the laser-ablated created channels 205 enable the electrolyte to better penetrate the electrode 200.

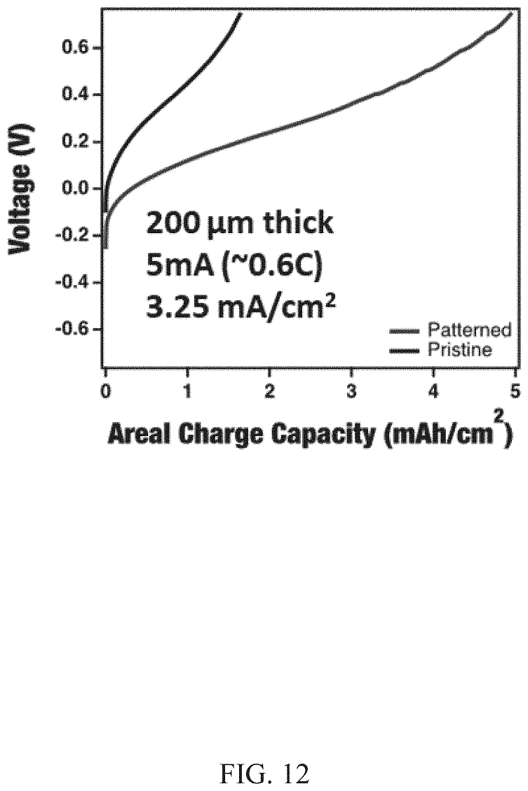

FIG. 12 illustrates the capacity achieved during an approximately 0.6 C constant current charge for pristine and laser ablation-treated electrodes, showing an improvement in the state of charge (SOC) for the electrodes treated with laser ablation, according to some aspects of the present disclosure. On the graph, “patterned” refers to electrodes 200 which had been treated with laser ablation to form channels 205 in a “pattern”, as described in some embodiments herein and “pristine” refers to typical, untreated electrodes. As shown in FIG. 12, during constant current charging at about 0.6 C, the untreated electrode was only able to reach approximately 20% SOC (an area charge capacity of about 1.5 mAh/cm²) before the cut off voltage of about 0.75 V was reached. The electrode 200 which had channels 205 (not shown in FIG. 12) created by laser ablation was able to reach approximately 70% SOC (an area charge capacity of about 5 mAh/cm²) under identical operating conditions, a dramatic improvement in rate performance.

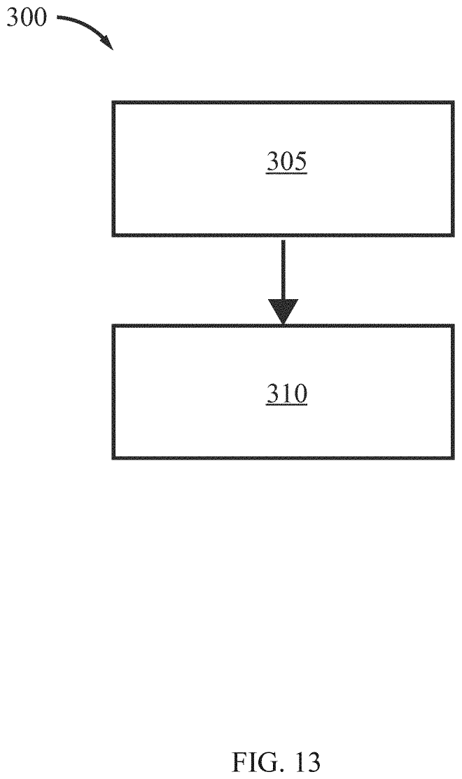

FIG. 13 illustrates a method 300 for improving the performance of a lithium-ion battery, according to some aspects of the present disclosure. The method 300 includes first forming 305 a channel 205 from an electrode 200 using a laser 105. The channel 205 may extend through at least a portion of the thickness of the electrode 200. The forming 305 may be done using laser ablation wherein the laser applies intense pulses of heat to very small areas of the electrode 200. The short (i.e., around 1 trillionth of a second) pulses of intense heat may burn/ablate the electrode 200 material it strikes without impacting other material nearby.

In some embodiments, the forming 305 may include repeating laser pulses, to “chip” away electrode 200 material, forming a channel 205. The channel 205 may extend through the width of the electrode 200 if it is a location where the electrode 200 will be bent or rolled upon assembly of the lithium-ion battery. The forming 305 may be performed during the manufacture of the lithium-ion battery and may be combined with the manufacture of the electrode 200.

In some embodiments, the method 300 next includes applying 310 an electrolyte to the electrode, resulting in at least a portion of the electrolyte being present in the channel 205. Applying 310 may refer to partial or complete filling of the channel 205 with electrolyte. The applying 310 may be performed during manufacturing of the lithium-ion battery, when electrolyte is applied to the electrode 200. In some embodiments, as a result of the applying 310 the electrolyte may be absorbed into the electrode 200.

In some embodiments, the lithium-ion electrodes may be thick (i.e., greater than about 100 μm) electrodes. In some embodiments, the electrodes may be graphite anodes and/or lithium nickel manganese cobalt oxide (Li₁Ni_{1-x-y}MnₓCo_{y}O₂ or NMC) cathodes for rechargeable lithium-ion battery electrodes. The electrodes may be for use in a jelly roll lithium-ion battery design and may have a significant length which can be wound up to form the battery. In some embodiments, the electrode may be a LiNi_{0.5}Mn_{0.3}Co_{0.2}O₂ or NMC532 cathode.

In some embodiments, the electrolyte may include lithium hexafluorophosphate (LiPF₆) salt dissolved in organic carbonates, such as ethylene carbonate (EC) with dimethyl carbonate (DMC), propylene carbonate (PC), diethyl carbonate (DEC), and/or ethyl methyl carbonate (EMC).

As used herein, the term “ablation” is used to refer to the removal or destruction of something from an object by vaporization, chipping, erosive processes, or by other means. In the present disclosure, ablation of at least a part of an electrode is performed using a laser to perform the ablation. The laser may burn or cut at least a portion of the electrode, resulting an incision. In some embodiments, the incision may extend through the entire depth of the electrode (i.e., form a hole in the electrode). In some embodiments, the incision may extend only partially into the depth of the electrode (i.e., forming a change in thickness of the electrode at certain locations).

### EXAMPLES

Example 1. A device comprising:

a lithium-ion battery comprising:
an electrode having a channel; wherein:

the electrode comprises a length, a width, and a thickness,

the channel extends into a first portion of the length of the electrode,

the channel extends into a second portion of the width of the electrode, and

the channel extends into a third portion of the thickness of the electrode.

Example 2. The device of Example 1,

the first portion is in the range of about 5 μm to about 50 μm.

Example 3. The device of Example 1 or 2, wherein:

the first portion is less than the length of the electrode.

Examples 4. The device of Example 1 or 2, wherein:

the first portion is approximately equivalent to the length of the electrode.

Example 5. The device of any of Examples 1-4, wherein:

the second portion is in the range of about 5 μm to about 50 μm.

Example 6. The device of any of Examples 1-5, wherein:

the second portion is approximately less than the width of the electrode.

Example 7. The device of any of Examples 1-5, wherein:

the second portion is approximately equivalent to the width of the electrode.

Example 8. The device of any of Examples 1-7, wherein:

the third portion is in the range of about 5 μm to about 50 μm.

Example 9. The device of any of Example 1-8, wherein:

the third portion is less than the thickness of the electrode.

Example 10. The device of any of Example 1-9, wherein:

the third portion is about 100 μm or less.

Example 11. The device of any of Examples 1-10, further comprising:

an electrolyte.

Example 12. The device of Example 11, wherein:

a portion of the electrolyte is present in the channel.

Example 13. A method for improving the performance of a lithium-ion battery, the method comprising:

forming a channel in an electrode of the lithium-ion battery using a laser source configured to emit a beam; wherein:

the beam comprises a size,

the electrode comprises a length, a width, and a thickness,

the channel extends into a first portion of the length of the electrode,

the channel extends into a second portion of the width of the electrode, and

the channel extends into a third portion of the thickness of the electrode.

Example 14. The method of Example 13, wherein:

the size of the beam comprises approximately 10 μm.

Example 15 The method of Example 13, wherein:

the size of the beam comprises approximately 40 μm.

Example 16. The method of any of Examples 13-15, wherein:

the first portion is approximately equivalent to the size of the beam.

Example 17. The method of any of Examples 13-16, wherein:

the first portion is less than the length.

Example 18. The method of any of Examples 13-16, wherein:

the first portion is approximately equivalent to the length.

Example 19. The method of any of Examples 13-18, wherein:

the second portion is approximately equivalent to the size of the beam.

Example 20. The method of any of Examples 13-19, wherein:

the second portion is approximately less than the width.

Example 21. The method of any of Examples 13-19, wherein:

the second portion is approximately equivalent to the width.

Example 22. The method of any of Examples 13-21, wherein:

the third portion is approximately equivalent to the size of the beam.

Example 23. The method of any of Examples 13-22, wherein:

the third portion is less than the thickness.

Example 24. The method of any of Examples 13-23, wherein:

the third portion is about 100 μm or less.

Example 25. The method of any of Examples 13-24, wherein the forming comprises:

pulsing the laser to remove material from the electrode to form the channel.

Example 26. The method of any of Examples 13-25, further comprising:

applying an electrolyte to the electrode; wherein:

during the applying a portion of the electrolyte is present in the channel.

Example 27. The method of Example 26, wherein:

the portion of the electrolyte is absorbed into the electrode after the applying.

Example 28. The method of any of Examples 13-27, wherein:

the forming is performed using a femtosecond laser.

Example 29. The method of Example 28, wherein:

the femtosecond laser has a pulse-width of approximately 600 fs, an output at 1030 nm, a repetition rate between 100 kHz and 1 MHz, and an average power of 10 MW.

Example 30. A system for performing laser ablation on an electrode of a lithium-ion battery, the system comprising:

a laser source configured to emit a beam;

a laser optics; and

a stage configured to hold the electrode; wherein:

the laser optics is configured to direct the beam to perform laser ablation on the electrode which results a channel on the electrode.

Example 31. The system of Example 30, wherein:

the laser source comprises a femtosecond laser.

Example 32. The system of Example 31, wherein:

the femtosecond laser has a pulse-width of approximately 600 fs, an output at 1030 nm, a repetition rate between 100 kHz and 1 MHz, and an average power of 10 MW.

Example 33. The system of any of Examples 30-32, wherein:

the laser optics comprises at least one of a laser mirror, a laser lens, a laser window, a laser filter, ultrafast optics, laser beam expanders, laser beam splitters, a crystal, an isolator, a speckle reducer, and/or a laser prism.

Example 34. The system of any of Examples 30-33, wherein:

the laser optics comprises a galvo-mirror beam steering assembly.

Example 35. The system of Example 34, wherein:

the galvo-mirror beam steering assembly comprises a f-theta scanning lens.

Example 36. The system of any of Examples 30-35, wherein:

the laser optics comprises a beam steering optics, and

the beam steering optics are coated for 1030 nm.

Example 37. The system of any of Examples 30-36, wherein:

the stage for the battery comprises:
a vacuum sample mount.

Example 38. The system of any of Examples 30-37, further comprising:

a gas source; wherein:

the gas source is oriented towards the stage, and

the gas source is configured to remove any debris caused by the laser ablation.

Example 39. The system of Example 38, wherein:

the gas source comprises an inert gas.

Example 40. The system of Example 39, wherein:

the inert gas comprises nitrogen.

Example 41. The system of any of Examples 30-40, wherein:

the beam comprises a size,

the electrode comprises a length, a width, and a thickness,

the channel extends into a first portion of the length of the electrode,

the channel extends into a second portion of the width of the electrode, and

the channel extends into a third portion of the thickness of the electrode.

Example 42. The system of Example 41, wherein:

the size of the beam comprises approximately 10 μm.

Example 43. The system of Examples 41 or 42, wherein:

the size of the beam comprises approximately 40 μm.

Example 44. The system of any of Examples 41-43, wherein:

the first portion is approximately equivalent to the size of the beam.

Example 45. The system of any of Examples 41-44, wherein:

the first portion is less than the length of the electrode.

Example 46. The system of any of Examples 41-44, wherein:

the first portion is approximately equivalent to the length of the electrode.

Example 47. The system of any of Examples 41-46, wherein:

the second portion is approximately equivalent to the size of the beam.

Example 48. The system of any of Examples 41-47, wherein:

the second portion is approximately less than the width of the electrode.

Example 49. The system of any of Examples 41-47, wherein:

the second portion is approximately equivalent to the width of the electrode.

Example 50. The system of any of Example 41-49, wherein:

the third portion is approximately equivalent to the size of the beam.

Example 51. The system of any of Example 41-50, wherein:

the third portion is less than the thickness of the electrode.

Example 52. The system of any of Example 41-51, wherein:

the third portion is about 100 μm.

Example 53. The system of any of Examples 41-51, wherein:

the third portion is less than about 100 μm.

Example 54. The system of any of Examples 30-53, further comprising:

an electrolyte.

Example 55. The system of Example 54, wherein:

a portion of the electrolyte is present within the channel.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A device comprising:
a lithium-ion battery comprising:
an electrode having a channel; wherein:
the electrode comprises a length, a width, and a thickness,
the channel extends into a first portion of the length of the electrode,
the channel extends into a second portion of the width of the electrode, and
the channel extends into a third portion of the thickness of the electrode.

2. The device of claim 1,
the first portion is between 5 μm and 50 μm.

3. The device of claim 1, wherein:
the second portion is between 5 μm and 50 μm.

4. The device of claim 1, wherein:
the second portion is approximately equivalent to the width of the electrode.

5. The device of claim 1, wherein:
the third portion is between 5 μm and 50 μm.

6. The device of claim 1, wherein:
the third portion is less than 100 μm.

7. The device of claim 1, further comprising:
an electrolyte; wherein:
a portion of the electrolyte is present in the channel.

8. A method for improving the performance of a lithium-ion battery, the method comprising:
forming a channel in an electrode of the lithium-ion battery using a laser source configured to emit a beam; wherein:
the beam comprises a size,
the electrode comprises a length, a width, and a thickness,
the channel extends into a first portion of the length of the electrode,
the channel extends into a second portion of the width of the electrode, and
the channel extends into a third portion of the thickness of the electrode.

9. The method of claim 8, wherein:
the first portion is approximately equivalent to the size of the beam.

10. The method of claim 8, wherein:
the first portion is approximately equivalent to the length.

11. The method of claim 8, wherein:
the second portion is approximately equivalent to the size of the beam.

12. The method of claim 8, wherein:
the second portion is approximately equivalent to the width.

13. The method of claim 8, wherein:
the third portion is approximately equivalent to the size of the beam.

14. The method of claim 8, wherein:
the third portion is less than about 100 μm.

15. The method of claim 8, wherein:
the forming comprises:
pulsing the laser to remove material from the electrode to form the channel.

16. The method of claim 8, further comprising:
applying an electrolyte to the electrode; wherein:
during the applying a portion of the electrolyte is present in the channel.

17. A system for performing laser ablation on an electrode of a lithium-ion battery, the system comprising:
a laser source configured to emit a beam;
a laser optics; and
a stage configured to hold the electrode; wherein:
the laser optics is configured to direct the beam to perform laser ablation on the electrode which results a channel on the electrode.

18. The system of claim 17, wherein the laser source comprises a femtosecond laser.

19. The system of claim 17, wherein:
the laser optics comprises at least one of:
a laser mirror, a laser lens, a laser window, a laser filter, ultrafast optics, laser beam expanders, laser beam splitters, a crystal, an isolator, a speckle reducer, and/or a laser prism.

20. The system of claim 17, further comprising:
a gas source; wherein:
the gas source is oriented towards the stage, and
the gas source is configured to remove any debris caused by the laser ablation.
